(19) United States
(12) Patent Application Publication
(10) Pub. No.: US 2026/0158707 A1
(43) Pub. Date: Jun. 11, 2026

(54) Separation Device Having a Strip-Shaped Separation Element

(71) Applicant: kocher-plastik Maschinenbau GmbH, Sulzbach-Laufen (DE)

(72) Inventors: Steffen Julinek, Sulzbach-Laufen (DE); Simon Hörner, Gaildorf (DE); Bert Schulze, Aalen (DE); Jan Waldenmaier, Sulzbach-Laufen (DE)

(73) Assignee: kocher-plastik Maschinenbau GmbH, Sulzbach-Laufen (DE)

(21) Appl. No.: 18/707,079

(22) PCT Filed: Oct. 17, 2022
(86) PCT No.: PCT/EP2022/078835

§ 371 Date: May 2, 2024

(30) Foreign Application Priority Data
Nov. 6, 2021 (DE) 10 2021 005 494.6

(51) Int. Cl. B29C 33/44; B29C 48/00; B29K 101/12; B29L 31/00

(52) U.S. Cl. CPC B29C 33/442; B29C 48/0011; B29C 48/0022; B29K 2101/12; B29L 2031/7158

(57) ABSTRACT

A separation device comprising a separation element which is held by a holding device. The separation device being movably guided in opposite feed directions by a drive device and carrying out a separation process on separation stock in at least one direction, wherein the separation element is in the form of a strip, the holding device receives the separation element between opposing holding parts, and the separation element is moved through the separation stock along a curve by using the holding device.

### CROSS-REFERENCE TO RELATED APPLICATIONS

This application claims priority to German Patent Application No. DE 10 2021 005 494.6, filed on Nov. 6, 2021 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a separation device comprising a separation element which is held by a holding device, which is movably guided in opposite feed directions by means of a drive device and carries out a separation process on separation stock in at least one direction.

WO 02/49821 A2 discloses a device for producing and filling containers, having at least one mould comprising movable mould walls, into which at least one tube of plasticised plastic material can be extruded, the mould parts of which can be closed in order to weld the leading end of the tube by means of welding edges located thereon to form a container base, having a device for generating a pressure gradient which acts on the tube and expands it to form the container on the mould walls, having a movable cutting edge which can be moved between a retracted home position and a working position to form a filling hole by cutting through the tube above the mould, and having a displacement device for moving the mould into a filling position for filling the container through the filling hole, wherein a cover plate which can be moved and heated together with the cutting edge is provided as a sterile cover, which is provided in such a positional arrangement and with such dimensions that, in the working position of the cutting edge, the cover plate is located above the path of movement of the mould leading into the filling position and covers the filling hole. The hot cutting edge is used to sever the tube and has a wedge shape with conical separating surfaces. Covering the filling hole of the tube with a sterile barrier plate is intended to counteract the risk of particles or possibly ambient air containing germs being able to enter the open filling hole after the tube has been severed before the mould has reached the sterile filling room. In this case, the barrier plate is heated to a germicidal temperature, for example of more than 150° C.

Despite these precautions, oxidation and decomposition products and fume particles, also referred to in the following as contaminants for short, are caused by combustion processes of the plastic material when the plastic tube is correspondingly cut while hot, in particular on the wedge-shaped, hot separating surfaces, the contaminants being produced by the cut directly between the barrier plate and the filling hole. The barrier plate therefore directs contaminants into the interior of the tube and thus into the container interior rather than preventing this. Moreover, the barrier plate prevents efficient contaminants from being efficiently extracted from the region of the filling hole. The actual problem of the cutting process, namely the formation of particulate contaminants in particular, is not addressed by this prior art.

### SUMMARY

A need exists to provide an improved cutting devices. The need is addressed by a separation device with the features of the independent claim(s). Embodiments of the invention are described in the dependent claims, the following description, and the drawings.

### BRIEF DESCRIPTION OF THE DRAWINGS

FIGS. 1 and 2 shows a perspective top view of example components of the separation device using an electric motor or a pneumatic cylinder as part of the drive device;

FIG. 3 shows an end-face view of an example 8-fold tube head together with an example retaining jaw arranged underneath it and with the separation device according to FIG. 1 arranged therebetween;

FIG. 4 is viewed in cross-section, and shows an example strip design for the separation element of the separation devices according to FIGS. 1 and 2; and

FIG. 5 shows in a perspective top view, a partial detail of the example retaining jaw with the tube head dispenser arranged above it and the separation element arranged therebetween, which is displaceably guided along curved path above the retaining jaw.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a separation element of a separation device is strip-shaped, a holding device receives the separation element between opposing retaining parts, and the separation element can be moved through the separation stock along a curved path using the holding device. This means that low-contamination separation of a plastic tube is achieved in the sense outlined above, particularly during the production of blow-moulded, filled and sealed container products. For an average person skilled in the art, the strip-shaped separation element which is guided along a curved path and can be heated in a controlled manner, surprisingly results in a reduced formation of solid and/or liquid and/or gaseous contaminants during the separation process. The arc-shaped separation or cutting path also makes it possible to sever the tube very close to the upper side of a retaining jaw or a tube gripper which results in effective use of material. In this respect, it is also possible to supply and/or extract low-particle and low-germ clean air between the said retaining jaw/tube gripper and the separation element. The arc-shaped separation or cut guidance only minimises the formation of contaminants, if at all, since in this respect there is only minimum edge contact between the separation element or the cutting blade and the tube. This is surprising, as this effect occurs despite the longer cutting path according to the teachings herein compared to a straight cut, as illustrated in the prior art.

With the separation device solution according to the teachings herein, it is also possible to obtain improved separation or cutting geometries on the tubular material, which makes it easier to carry out subsequent processing steps. Furthermore, the masses to be moved are reduced in that it is just sufficient to move an lightweight separation element back and forth along the opposing curved feed directions using the holding device, in contrast to the previously described solid configuration with a hot barrier plate and wedge-shaped cutting edge according to the aforementioned WO 02/49821 A2, which improves the precision in the separation process according to the teachings herein and enables an expedient flow of low-particle and low-germ clean air in the first place.

In some embodiments, it is provided that the separation element is received in the holding device at a predefinable inclination with respect to the respective feed direction. For example, the strip-shaped separation element is received in the holding device at an angle of inclination which is between 3 and 15°, or for example between 3 and 10°, with respect to the horizontal in order to obtain the predefinable inclination, so that an associated separating edge, viewed vertically, is arranged at the bottom of the separation element during a horizontal feed movement of the separation element. When the separating edge hits the separation stock, commonly in the form of a tube, the wall portions to be severed are progressively separated in a linear manner and, due to the slightly increasing inclination of the separation element with respect to a reference horizontal, the separation element being otherwise guided along a curved path, a low impact separation process takes place while minimising the formation of contaminants of any kind. In this case, the separated plastic material is guided almost force-free on the upper side of the strip-shaped separation element, whereas the lower tube portion moves away from the separation element as a result of the process, so that contaminants due to unintentional heat input cannot arise in this region at all. In particular, the separation process achieves smooth wall parts at the separation point which helps to facilitate the subsequent forming processes in the production machine.

In the context of low-contamination separation, it has proven beneficial for the separation element to be provided with two opposing surfaces extending parallel to each other, starting from its separating edge while forming the strip, it having proven particularly beneficial for the separation element to be asymmetrical, when viewed in cross-section, and to provide a concave surface on a side which is directed towards the feed direction of the separation stock and has a convex curvature on the opposing side. Instead of the convex curvature, good results can also be achieved if the opposing side extends rectilinear in a horizontal plane. In cooperation with the concave/convex strip surface of the separation element with the movement thereof along the curved path, this results in particularly good separation processes while largely preventing the formation of contaminants.

In some embodiments, it is provided that the separation element, as part of a resistance heater, can be electrically heated and for example the temperature of the separation element is controlled and monitored, for example using at least one thermocouple. Apart from the thermocouple mentioned, the temperature can be measured alternatively or additionally by non-contact, optical temperature measurement, for example using a pyrometer or an infrared camera, and the values obtained in this manner can be included in the temperature control for the separation process.

By controlling the current, it is possible to adjust the temperature of the cutting or r separating strip to a desired temperature and keep it constant. It is understood that the optimum strip temperature depends on the plastic used for the tube material and also depends on the specific tube geometry as well as the wall thickness of the tube.

In a beneficial manner, the strip-shaped separation element can be heated up briefly to much higher temperatures in the stationary state in order to ensure sterility. Any contaminants adhering to the separation element are burned off selectively here in advance and not during actual cutting of the tube, with additional extraction of the combustion gases arising, the inclination of the separation element with respect to the horizontal contributing significantly to improved flow guidance.

To compensate the thermal linear expansion of the strip-shaped separation element due to different temperatures and to keep it in a taut position at all times for upcoming cutting or separation processes, it is beneficial to design the holding device as a retaining bracket which in this respect, with its opposing bracket parts as the retaining parts, holds the strip-shaped separation element under tension at its free strip ends, for example with a predefinable preload. In this way, the separation element can also have a lower width and/or thickness in terms of its strip dimensions at much lower operating temperatures and still have the mechanical stability required for the separation processes mentioned, which benefits the desired cutting quality. In particular, the rigidity of the strip material can be significantly increased in this way at the low application temperatures addressed according to the teachings herein. This in turn enables additional reduction of the contact surface between tube and strip-shaped separation element, taking its inclination into account, and thus contributes to minimising fume formation and consequently to minimising the contaminants mentioned, in addition to the reduced temperature.

In principle, the strip-shaped separation element can also be operated “cold”, i.e., without additional heat supply to the separation element, provided that the separation stock, in the form of the tube, has corresponding geometric and mechanical properties at the prevailing temperature which are suitable for the separation process.

It has shown to be particularly cost-effective in the implementation to use an electric motor or a linear drive, such as a pneumatic cylinder, as the drive device, the respective axis of rotation of which forms a pivot axis for the holding device which is hinged on the drive with its one free end face and held free of a bearing with its other end face. This enables delay-free actuation of the separation element along the curved track.

In some embodiments, it is provided that an extraction device is provided below the lowest point of the curve achieved with the separation element, with at least one supply for a gaseous medium (for example low-particle and low-germ air) and a corresponding discharge for the aforementioned medium, and in that the supply and discharge are arranged on opposing sides of the extraction device which are at least partially swept over by the separation element on its curved path. In this way, any possible contaminants arising in the region of the separation process can be removed from the separation region of the tube promptly and effectively.

The separation device can be used for a method which for example serves to produce a moulded, filled and sealed container product and has at least the following method steps:
Extruding a tube by means of an extrusion device, for example using supporting gas, in the vertical extrusion direction,
For example closing of the tube at its lower end,
Applying a retaining jaw and/or a tube gripper to the tube,
Severing the tube as the separation stock at its upper open end with the aid of the separation device according to the teachings herein,
Forming a tube portion severed in this manner in a moulding tool using a pressure gradient,
Filling and sealing the moulded tube portion, and
Opening the moulding tool and removing the sealed container product.

In this way, a very low-contamination method is implemented in which large quantities of finished container products can be reliably produced by severing tube portions using the discussed separation device.

The teachings herein further relates to a container product, produced in particular using a separation device and a method as described above, in which thermoplastic polymers containing cycloolefin (COC, COP), fluorine and/or chlorine are used as the plastic material. The separation device is particularly important in this field of application for container production, as it can be used to carry out low-contamination separation processes even at low temperatures in order to reliably prevent highly toxic and corrosive gases containing fluorine or chlorine, for example, from being produced during the separation process, which gases are already unacceptable for reasons of occupational health and safety.

The separation device is explained in greater detail below with reference to an embodiment according to the drawing. The drawings show in principle and not to scale as well as greatly simplified. Specific references to components, process steps, and other elements are not intended to be limiting. Further, it is understood that like parts bear the same or similar reference numerals when referring to alternate FIGS.

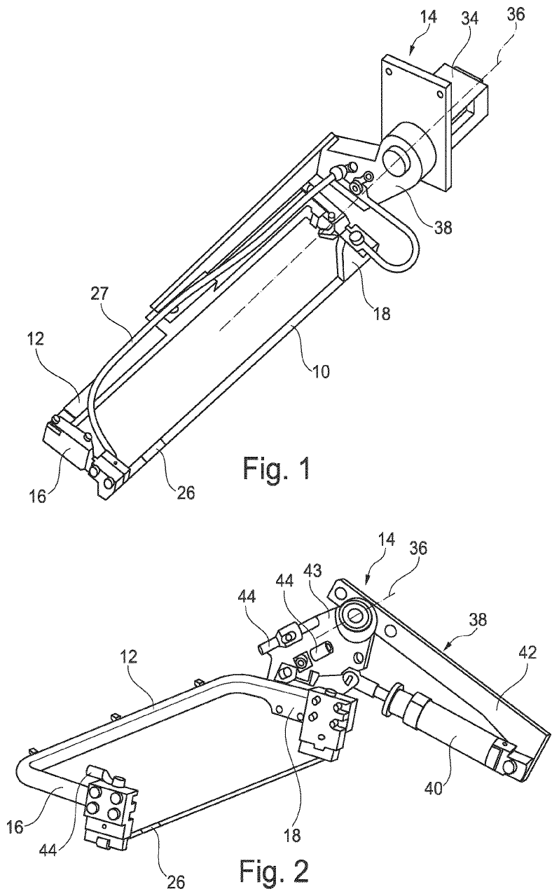

The separation device shown in FIG. 1 comprises a separation element 10 which is held by a holding device 12, which is movably guided in opposite curved or arched feed directions by means of a drive device 14. The said two feed directions (forwards and backwards) are located in a common curved path which can form a segment of a circle and the lowest point of which, viewed vertically, is shown in FIG. 5. In the present embodiment, the Separation element 10 is guided by means of the bracket-like holding device 12 for a separation process on a separation stock in the form of at least one extruded, warm plastic tube, the separation element 10, viewed in the direction of FIG. 1, moving forwards towards the viewer in the one curved feed direction for the separation process and after completion of the separation process, the separation element 10 moving back in the opposite feed direction.

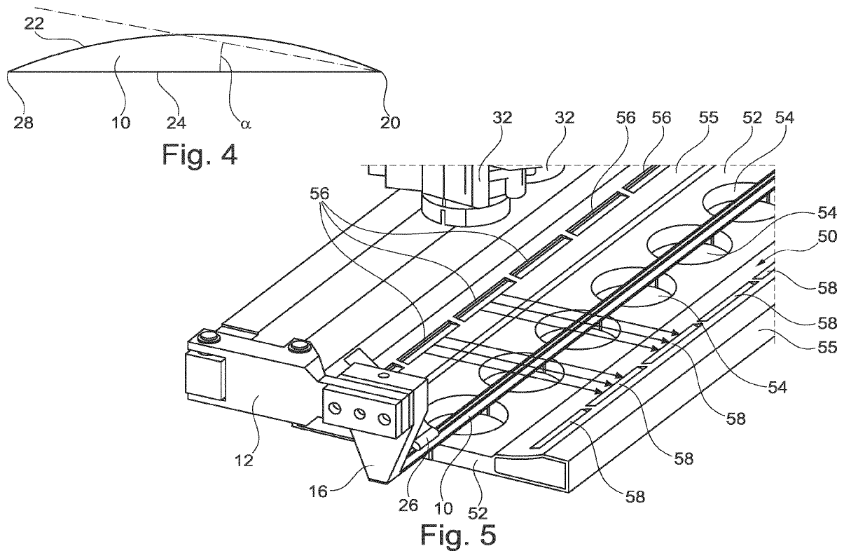

As can further be seen from FIG. 1, the separation element 10 is strip-shaped and the holding device 12 holds the separation element 10 between opposing arm-like retaining parts 16, 18. As FIG. 4 shows, the strip-shaped separation element 10 can be held in the holding device 12 at the ends at an angle of inclination α to obtain a predefinable inclination, which, by way of example, is intended to be approximately 5° for the present embodiment, viewed from the horizontal, but which is not shown to scale in FIG. 4 for the sake of simplification. It is understood that, according to the diagram shown in FIG. 4, an associated lower separating edge 20, viewed in the vertical, is arranged at the very bottom of the strip-shaped separation element 10 when the separation element 10 moves forwards in an arc as described.

Furthermore, the separation element 10, starting from this separating edge 20 and forming the strip, can have two opposing strip surfaces (not shown) extending parallel to each other, in a for example configuration according to the diagram shown in FIG. 4, viewed in cross-section, the separation element 10 is asymmetrical and is concave on a side 22 which directed towards the upper vertical feed direction of the separation stock in the form of at least one tube and is flat on the opposing side 24. In an embodiment not shown in greater detail, there is also the option to make the lower strip surface 24 convex depending on the material of the separation stock to be cut.

The separation element 10, as part of a resistance heater, can be electrically heated, the respective temperature of the separation element 10 being monitored using at least one thermocouple 26, only shown schematically, which is attached to the left-hand end of the separation element 10, viewed in the direction of FIG. 1. FIG. 1 shows the electrical supply lines 27 leading to the separation element 10. However, there is also the option, if necessary, to implement the power supply directly via the arm-like retaining arms 16, 18. By controlling the current as part of the resistance heater, it is possible to adjust and control the temperature of the strip-shaped separation element 10 shown to a desired temperature. Typically, constant voltages between 5 and 25 V AC with variable currents ranging from 5 to 150 A are used. Highly flexible, mineral-insulated type K elements for example used as the thermocouple 26. The optimum strip temperature can be adjusted in this respect by the temperature control, depending on the plastic used for the extruded tube and its geometry and wall thickness. The separation of halogenated plastics, such as PFA/MFA, FEP, PVDF, ETFE and ECTFE as well as PCTFE, in particular plastics containing fluorine, takes place at temperatures of 80° C. to 300° C., or at 100° C. to 250° C., or at 180° C. to 230° C., the abbreviations selected above for the plastic are obtained from ISO 1043-1:2016-09.

In a beneficial manner, the strip-like separation element 10 or the cutting strip is heated up briefly to much higher temperatures in the stationary state in order to ensure sterility. This allows any contaminants adhering to the separation element 10 to be removed selectively outside the actual separation process or cutting of the tube and the resulting gases or vapours to be extracted. To compensate the linear expansion of the separation element 10 due to the increased temperature and to always keep it in a taut position for a separation process, it is expedient to insert the separation element 10 into the retaining parts 16, 18 of the holding device 12 with a predefinable mechanical tension. However, it is also possible to provide the two retaining arms 16, 18 with a clamping force in the opposite direction via a preloading device, not shown in greater detail, so as to be able to exert a preload on the separation element 10 in this manner.

Due to much lower operating temperatures compared to the prior art, the separation element can accordingly also have a smaller width and/or thickness and still provide sufficient mechanical stability for the separation process, as the rigidity of the material for the separation element 10 is inevitably much higher in view of the low application temperatures. This in turn also enables additional reduction of the possible contact surface between the extruded tube and the separation element 10 and thus also contributes to minimising the undesirable formation of contaminants, in addition to the reduced operating temperature.

According to the diagram shown in FIG. 4, the separation element 10 has an average thickness of approximately 1 mm and a width of approximately 10 mm, measured from the separating edge 20 to the rear side 28 of the separation element 10. Depending on the number of tubes of a multiple tube head 30 to be severed, as shown in a greatly simplified form and only in sections in FIG. 2, the separation element 10 can have a length of up to approximately 400 mm; measured in the horizontal orientation between the retaining parts 16, 18. This length is therefore sufficient if, as in the present case, the multiple tube head 30 has eight extrusion nozzles 32 for eight plastic tubes emerging simultaneously (not shown). Again depending on the plastic material used, an example separating or cutting speed for the separation element 10 ranges from 100 to 600 mm/s, or for example between 200 and 500 mm/s.

According to the disclosure, even thin-walled tubes made of specific lightweight polymers, such as polypropylene (PP), low-density polyethylene (LDPE) and cyclic olefin polymers (COP) and cyclic olefin copolymers (COC), can be separated with low contamination. It is also possible to cut multilayer tubes produced by co-extrusion, as shown for example in EP 1 616 549 B1, according to the teachings herein.

For example, polymer materials with a tensile modulus at ambient temperature according to DIN EN ISO 527 (2019-12) of less than 2.2 GPa, for example less than 2 GPa, are used. The cross-section of the tube to be cut can be substantially circular or, particularly in the production of ampoule blocks using the BFS process, have a more oval cross-section when partially collapsed.

To obtain the curved path of the separation element, an electric motor 34 is used, the drive axle of which forms a rotational axis 36 along which the bracket-like holding device 12 as a whole is pivotably guided via an associated pivot device 38.

In the embodiment according to FIG. 2, a linear drive in the form of a pneumatic cylinder 40 engages on the drive device 14 for the bracket-like holding device 12, the pneumatic cylinder 40, as part of the drive device 14, being pivotably articulated on its free housing side on a receptacle 42 and with its other rod side on a pivot mounting 43, which in turn pivotably engages on the receptacle 42 along a pivot or rotational axis 36. FIG. 2 also shows the connections 44 for the cable guide 27, which has been omitted in FIG. 2 for the sake of simplicity.

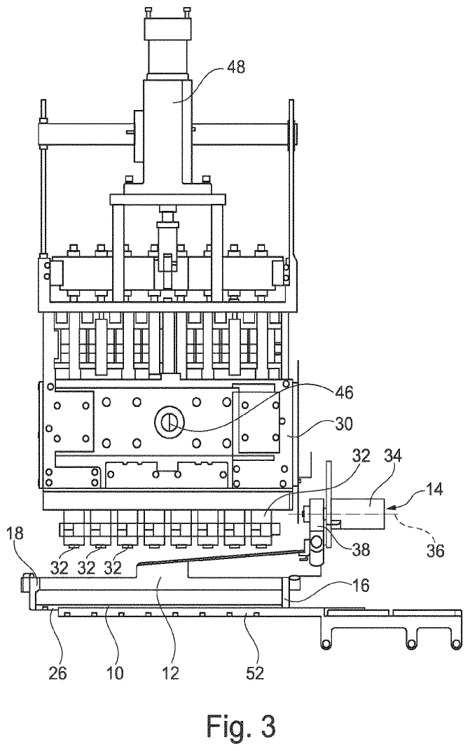

The production method using a separation device as described above is now illustrated in detail based on the diagram shown in FIG. 3. The method is used in particular to produce moulded, filled and sealed container products, for example ampoules or bottles. Accordingly, containers produced using the so-called BFS process are available on the market in a variety of embodiments, with the result that they will not be discussed in greater detail here. In particular, these are containers for medical purposes which, as lightweight containers, have a filling volume of less than 2 litres and/or an empty weight of less than 0.06 kg.

To obtain such container products, it is necessary to extrude a tube by means of a conventional extrusion device using supporting gases in the vertical extrusion direction. As part of the production process, the 8-fold tube head 30 according to FIG. 3 has a connection 46 to the aforementioned extrusion device on its front end face and the individual tubes are dispensed for further container production via the 8 dispensing nozzles 32 on the underside of the tube head 30. A retaining adjustment element 48 is used in the usual manner to adjust the position of the nozzles 32 and as part of the tube head 30.

For example, the respective tube is then closed at its lower end by applying a retaining jaw 52 to the tube. Instead of the retaining jaw 52 shown in FIG. 3, a tube gripper suitable for this purpose, corresponding to the post-published DE 10 2020 002 077.7, can also be used in the usual way. The tube is then severed at its upper, open end with the aid of the separation device as described above, where, according to the diagram shown in FIG. 1, the electric motor 34 serving as the drive device 14, which, when actuated accordingly, moves the holding device 12 forwards in an arc shape by means of the pivot mounting 38 in the one separating feed direction and in so doing carries out the separation process on the respective tube along the curved path by means of the separation element 10. The electric motor 34 then pivots the separation element 10 back to its starting position.

Typically, the plastic tube dispensed via the respective nozzle 32 is still heat softened during the separation process. A suitable retaining jaw solution is disclosed by way of example in WO 02/49821 A2 and a tube gripper is accordingly shown in the post-published DE 10 2020 002 077.7. The substantially circular-arc-shaped path (curved path) for the separation element 10 has a radius of approximately 100 mm to 300 mm, for example of 150 to 220 mm. If the electric motor 34 is configured as a stepper motor, different cutting speeds can be implemented even during a cutting cycle. For example, it is possible to approach the tube quickly, cut through it more slowly and move it quickly after the cut. During the cutting or separation process, there is only extremely low formation of particulate contaminants, since, in addition to the optimum low cutting temperature, the arc-shaped cut guidance and the asymmetrical geometry of the cutting strip, for example according to the configuration shown in FIG. 4, result in only a minimum contact surface in the sense of edge contact between the strip-shaped separating device 10 and the tube. This effect can be supported even further, provided that the separation element 10 received in the holding device 12 is inclined by a predefinable angle of inclination α with respect to a horizontal reference plane.

The pneumatic drive device 40 shown in FIG. 2 can also be used to achieve the arched or curved path for the strip-shaped cutting strip 10.

As FIG. 5 shows in particular, the retaining jaw 52 with its individual circular through openings 54 is defined at the edges by strips 55 which have slot-shaped supply openings 56 opposite each other in pairs and likewise slot-shaped discharge openings 58 for low-particle and low-germ air, also referred to below as clean air. Thanks to this clean air guidance, any contaminants occurring can be discharged in a targeted manner by the shortest possible route and furthermore, the clean air guidance also allows the open tube portion to be cooled as required, which helps to stabilise the opening produced in this respect. In this way, the clean air is guided horizontally in the manner of a barrier flow, as shown in FIG. 5 by the individual flow arrows extending parallel to each to each other from left to right and, as shown in FIG. 5, the direction of the clean air flow corresponds substantially to the direction of the separation process.

After the respective tube portion has been separated from the tube, it is moulded in a moulding tool in the usual way using a pressure gradient, the container thus obtained then being in turn filled and sealed in the usual way. After opening the moulding tool and removing the sealed and in this respect finished container product, the production process is completed, which in some embodiments allow virtually continuous production of container products of any kind within the scope of the BFS process. The separation referred to is for example carried out at small distance from the retaining jaw 52 according to FIG. 3 or to a tube gripper used, for example with a minimum gap of less than 5 mm, for example less than 3 mm. Plastic tubes and separated tube portion made of plastic materials consisting of at least one semi-crystalline or amorphous polyolefin, which have an average weight of less than 0.1 kg, for example less than 0.07 kg, and an average wall thickness of less than 0.5 cm, for example less than 0.2 cm, have proven to be particularly suitable with the scope of separation. For example, BFS containers made of halogenated polymers, in particular fluoropolymers such as PVDF, can be produced using the method according to the teachings herein including the separation device described. Such containers, which also include ampoule products, are particularly suitable for holding medicinal products which contain partially fluorinated alkanes, in particular perfluorohexyloctane for inhalants. They are also suitable for ophthalmic preparations, for example for poorly water-soluble prostaglandin analogue active ingredients (EP 2 110 126 B9, US 2020/0360285 A1).

Furthermore, it is possible to fill medicinal products in which dimethyl sulfoxide (DMSO) is used, for example for pain-relieving gels and sprays, also in combination with diclofenac and heparin, as well as for wart treatment with fluorouracil.

For veterinary medicinal products, containers made of fluorinated polymers can be beneficially used for liquid antiparasitics which contain n-methyl-2-pyrrolidone as a solvent and imidacloprid, permethrim and/or butylated hydroxytoluene (E321) and/or butylated hydroxyanisole (E320).

BFS containers consisting at least partially of fluorinated polymers or cyclic olefin polymers (COP) or cyclic olefin copolymers (COC) are particularly important in the packaging of liquid medicinal products, the formulation components of which tend to be absorbed by container surfaces made of glass, polyethylene or polypropylene. These include, for example, flavouring substances or preservatives, such as benzalkonium chloride, benzoates and the preservatives m-cresol and phenol typically used for insulin.

Furthermore, the BFS containers made of fluorinated polymers or polymers containing cyclic olefins (COC, COP) which are produced using the method and device according to the teachings herein are suitable for packaging formulations containing at least one protein as the active ingredient, which tends to be absorbed (EP 3 572 061 A1). With the solution according to the teachings herein, it is possible to minimise the contaminants produced during separation or cutting of the tube using optimum strip temperatures which can be controlled polymer-specific and tube-geometry-specific and by achieving a minimum contact surface between the strip-shaped separation element 10 and the heat softened tube by means of the cutting strip dimensions and the geometry mentioned above and in particular by means of the inclined position with respect to a horizontal plane by the angle of inclination α.

In this way, a safe, smooth cut is achieved through thin-walled tubes of low specific weight and, by using the method according to the teachings herein, a high level of production reliability can be achieved by means of low-wear and low-maintenance operation of the separation device described. The separation device requires little installation space in BFS production machines and, due to the low space requirement, it is also possible to supply clean air together with extraction which significantly reduces the contamination risk for the container products. Since the separation device has only a small mass to be moved, substantially formed by the holding device 12 with the separation element 10, very fast cutting movements are possible, so that high production speeds can be achieved which helps to reduce the production costs for the BFS containers in question.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-11. (canceled)

12. A separation device comprising a separation element which is held by a holding device, which is movably guided in opposite feed directions using a drive device and carries out a separation process on separation stock in at least one direction, wherein
the separation element is strip-shaped;
the holding device receives the separation element between opposing retaining parts; and
the separation element can be moved through the separation stock along a curved path using the holding device.

13. The separation device of claim 12, wherein the separation element is received in the holding device at a predefinable inclination with respect to the respective feed direction.

14. The separation device of claim 12, wherein the strip-shaped separation element is received in the holding device at an angle of inclination which is between 3° and 15° with respect to the horizontal in order to obtain the predefinable inclination, so that an associated separating edge, viewed vertically, is arranged at the bottom of the separation element during a horizontal feed movement of the separation element.

15. The separation device of claim 12, wherein the Separation element, starting from its separating edge and forming the strip, has two opposing surfaces extending parallel to each other or in that, viewed in cross-section, the separation element is asymmetrical and is concave on a side which is directed towards the feed direction of the separation stock and is convex or rectilinear on the opposing side.

16. The separation device of claim 12, wherein the separation element, as part of a resistance heater, can be electrically heated.

17. The separation device of claim 12, wherein the temperature of the separation element and/or that of the separation stock is selected in such a manner that a melting process of the plastic material of the separation stock occurs.

18. The separation device of claim 12, wherein the drive device has an electric motor or a linear drive, the respective rotational axis of which forms a pivot axis for the holding device which is hinged on the respective drive with its one free side and held free of a bearing with its other free side.

19. The separation device of claim 12, wherein the holding device, configured as a holding bracket, holds the strip-shaped separation element at its free strip ends with opposing bracket parts as the retaining parts and exerts a mechanical preload on the separation element, at least during the separation process.

20. The separation device of claim 12, wherein an extraction device is provided below the lowest point of the curve achieved with the separation element, with at least one supply for a gaseous medium and a corresponding discharge for the aforementioned medium, and in that the supply and discharge are arranged on opposing ledges of the extraction device which are at least partially swept over by the separation element on its curved path.

21. A method for producing at least one moulded, filled and sealed container product, in particular in the form of an ampoule or bottle, comprising:
extruding a tube using an extrusion device in a vertical extrusion direction;
applying a retaining jaw and/or a tube gripper to the tube;
severing the tube as the separation stock at its upper open end with the aid of a separation device;
forming a tube portion severed in this manner in a moulding tool using a pressure gradient;
filling and sealing the moulded tube portion; and
opening the moulding tool and removing the sealed container product.

22. A container product made of plastic material produced with the method of claim 21, wherein thermoplastic polymers containing cycloolefin and/or fluorine and/or chlorine are used as the plastic material.

23. The separation device of claim 13, wherein the strip-shaped separation element is received in the holding device at an angle of inclination which is between 3° and 15° with respect to the horizontal in order to obtain the predefinable inclination, so that an associated separating edge, viewed vertically, is arranged at the bottom of the separation element during a horizontal feed movement of the separation element.

24. The separation device of claim 12, wherein the strip-shaped separation element is received in the holding device at an angle of inclination which is between 3° and 10° with respect to the horizontal in order to obtain the predefinable inclination, So that an associated separating edge, viewed vertically, is arranged at the bottom of the separation element during a horizontal feed movement of the separation element.

25. The separation device of claim 13, wherein the strip-shaped separation element is received in the holding device at an angle of inclination which is between 3° and 10° with respect to the horizontal in order to obtain the predefinable inclination, so that an associated separating edge, viewed vertically, is arranged at the bottom of the separation element during a horizontal feed movement of the separation element.

26. The separation device of claim 13, wherein the Separation element, starting from its separating edge and forming the strip, has two opposing surfaces extending parallel to each other or in that, viewed in cross-section, the separation element is asymmetrical and is concave on a side which is directed towards the feed direction of the separation stock and is convex or rectilinear on the opposing side.

27. The separation device of claim 14, wherein the separation element, starting from its separating edge and forming the strip, has two opposing surfaces extending parallel to each other or in that, viewed in cross-section, the separation element is asymmetrical and is concave on a side which is directed towards the feed direction of the separation stock and is convex or rectilinear on the opposing side.

28. The separation device of claim 12, wherein the separation element, as part of a resistance heater, can be electrically heated and the temperature of the separation element is monitored.

29. A container product made of plastic material produced with the separation device of claim 12, wherein thermoplastic polymers containing cycloolefin and/or fluorine and/or chlorine are used as the plastic material.

30. The separation device of claim 18, wherein the linear drive is a pneumatic cylinder.

31. The method of claim 21, comprising closing of the tube at its lower end.
